(19) United States
(12) Patent Application Publication
(10) Pub. No.: US 2010/0186559 A1
(43) Pub. Date: Jul. 29, 2010

(54) MULTI-USE, INTERCHANGEABLE TOOL

(75) Inventor: William Lee Pell, Sammamish, WA (US)

Correspondence Address: PAI PATENT & TRADEMARK LAW FIRM, 1001 FOURTH AVENUE, SUITE 3200, SEATTLE, WA, 98154, US

(73) Assignees: Kun-Chen Chen, Taichung Hsien (TW); PELL INDUSTRIAL LLC, Preston, WA (US)

(21) Appl. No.: 12/359,293

(22) Filed: Jan. 24, 2009

(51) Int. Cl. B25G 3/00

(52) U.S. Cl. 81/489

(57) ABSTRACT

A multi-use, interchangeable tool has a handle, an extension rod and an overhauling tool head. The handle has a mounting end and a first holding device mounted on the mounting end. The extension rod is telescopic and connected detachably to the handle with the first holding device and has a connecting end, a chuck and a second holding device. The connecting end is connected detachably to the mounting end of the handle with the first holding device. The mounting end is opposite to the connecting end. The second holding device is mounted on the mounting end. The overhauling tool head is connected detachably to the mounting end of the telescopic extension rod by the second holding device. Accordingly, the multi-use, interchangeable tool has changeable tool heads and is convenient to use and carry.

### BACKGROUND OF THE INVENTION

1. Field of the Invention

The present invention relates to a tool, and more particularly to a multi-use, interchangeable tool for overhauling a machine, a vehicle or the like having changeable tool heads.

2. Description of Related Art

To overhaul a machine or a vehicle, many kinds of different tools, such as mirrors, screwdrivers, wrenches, tweezers, clamps and so on have to be prepared and used, but storage of multiple different tools requires large space, is inconvenient and when a tool head or handle requires replacement due to rust-damage, use-damage or the like an entire tool must be purchased.

To overcome the shortcomings, the present invention tends to provide a multi-use, interchangeable tool to mitigate or obviate the aforementioned problems.

### SUMMARY OF THE INVENTION

The main objective of the invention is to provide a multi-use, interchangeable tool having changeable tool heads and is convenient to use and carry. The multi-use, interchangeable tool has a handle, an extension rod and a tool head. The handle has a mounting end and a first holding device mounted on the mounting end. The extension rod is telescopic and connected detachably to the handle with the first holding device and has a connecting end and a second holding device. The connecting end is connected detachably to the mounting end of the handle with the first holding device. The mounting end is opposite to the connecting end. The second holding device is mounted on the mounting end. The overhauling tool head is connected detachably to the mounting end of the telescopic extension rod with the second holding device.

Other objects, advantages and novel features of the invention will become more apparent from the following detailed description when taken in conjunction with the accompanying drawings.

### BRIEF DESCRIPTION OF THE DRAWINGS

FIG. 1 is a partially exploded perspective view of a multi-use, interchangeable tool in accordance with the present invention showing multiple different kinds of tool heads, which can be fitted with an extension rod of the multi-use, interchangeable tool;

FIG. 2 is an exploded perspective view of the extension rod and the handle of the multi-use, interchangeable tool in FIG. 1;

FIG. 3 is an enlarged side view in partial section of the first holding device on the handle of the multi-use, interchangeable tool in FIG. 1;

FIG. 4 is an operational side view in partial section of the second holding device on the extension rod of the multi-use, interchangeable tool in FIG. 1 fitting with a tool head; and

FIG. 5 is an operational perspective view of the multi-use, interchangeable tool in use.

### DETAILED DESCRIPTION OF PREFERRED EMBODIMENT

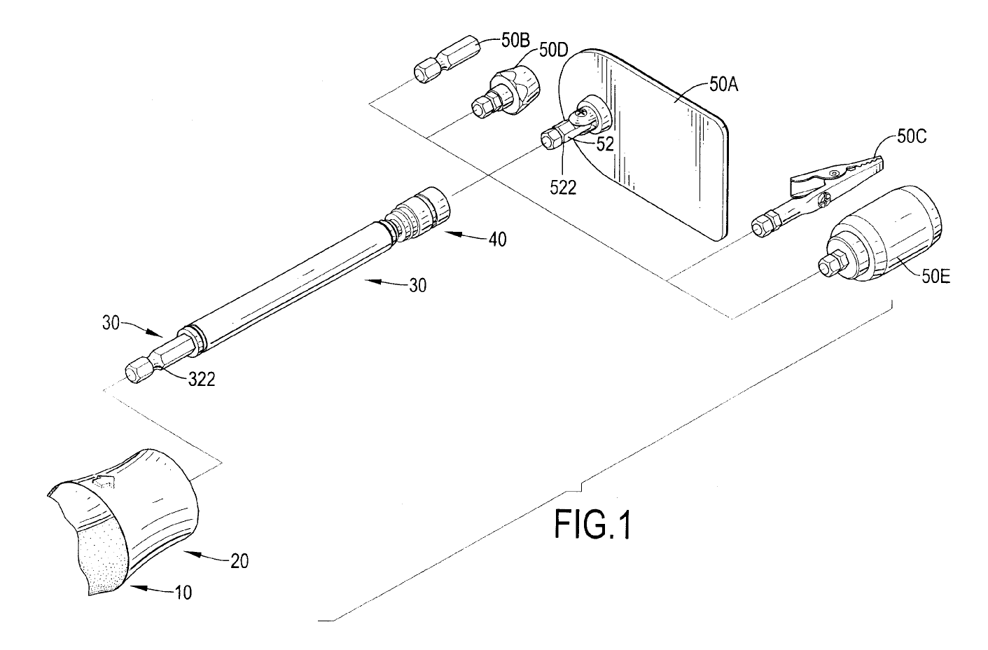

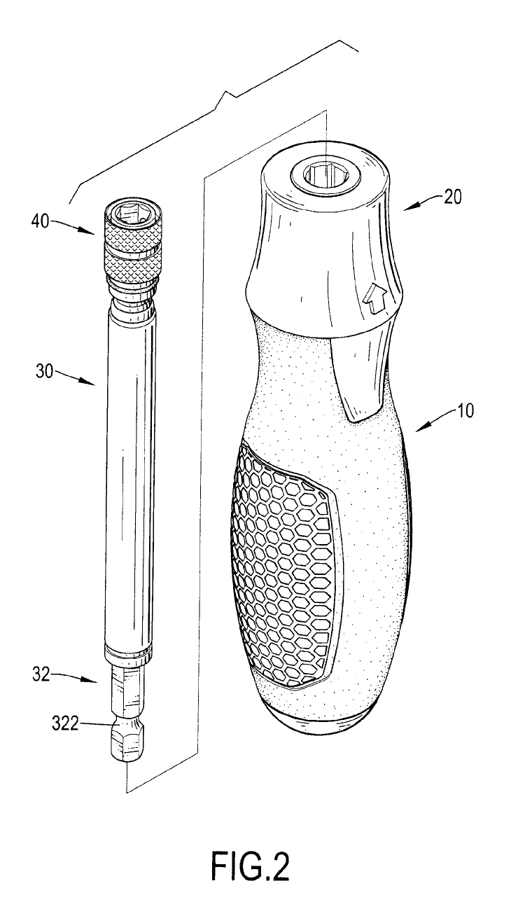

With reference to FIGS. 1 and 2, a multi-use, interchangeable tool in accordance with the present invention comprises a handle (10), an extension rod (30) and an overhauling tool head (50A, 50B, 50C, 50D, 50E).

The handle (10) may be made of a resilient material, such as plastic or rubber and has a mounting end and a first holding device (20) mounted on the mounting end.

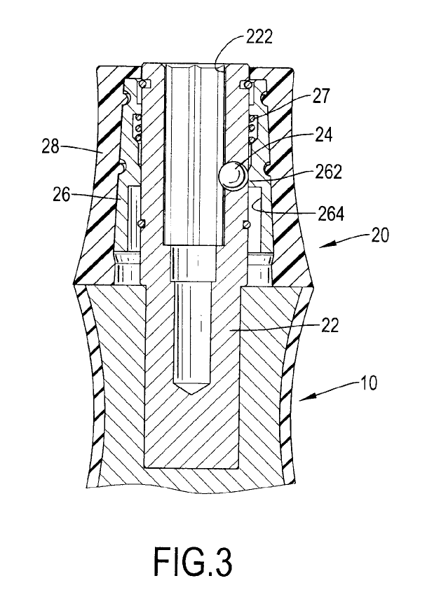

With further reference to FIG. 3, the first holding device (20) comprises a first connecting stub (22), a first holding ball (24), a first holding sleeve (26) and a first spring (27). The first connecting stub (22) is mounted on and protrudes from the mounting end of the handle (10). The first connecting stub (22) can be integrally formed on or securely attached to the handle (10) and has a free end and a first connecting hole (222). The first connecting hole (222) is non-circular, may be hexagonal and is defined in the free end of the first connecting stub (22). The first holding ball (24) is retractably mounted in the first connecting stub (22) and protrudes into the first connecting hole (222). The first holding sleeve (26) is slidably mounted around the first connecting stub (22) to press the first holding ball (24) to partially protrude into the first connecting hole (222) and allow the first holding ball (24) to retract from the first connecting hole (222). The first holding sleeve (26) has an inner surface and an annular abutting flange (262) formed on the inner surface. An annular holding recess (264) is defined in the inner surface of the first holding sleeve (26) below the abutting flange (262). When the first holding sleeve (26) is slid upwardly to make the annular holding recess (264) align with the first holding ball (34), the first holding sleeve (26) can provide a space for the first holding ball (24) to retract into from the first connecting hole (22).

The first spring (27) is held in the first holding sleeve (26) and is mounted around the first connecting stub (22). The first spring (27) provides a force to the first holding sleeve (26) to make the abutting flange (262) abut against the first holding ball (24) and to push the first holding ball (24) to partially protrude into the first connecting hole (22).

The first holding device (20) may further have an outer sheath (28) mounted around the first holding sleeve (26) made of a resilient material.

The extension rod (30) is telescopic and is composed of multiple tubes connected retractably together in series. The extension rod (30) has a connecting end, a mounting end, a first connecting shaft (32) and a second holding device (40). The first connecting shaft (32) is integrally formed on and protrudes from the connecting end of the extension rod (30), is detachably mounted in the first connecting hole (222) of the first holding device (20) and held by the first holding device (20) and has a non-circular cross section corresponding to the non-circular first connecting hole (222). Preferably, the first connecting shaft (32) is hexagonal in cross section. An annular engaging detent (322) is defined around and near one end of the first connecting shaft (32) and detachably engages the first holding ball (24) of the first holding device (20) after the first connecting shaft (32) is inserted into the first connecting hole (222). With the engagement of the detent (322) in the connecting shaft (32) and the first holding ball (24) of the first holding device (20), the extension rod (30) is connected securely, but detachably to the handle (10).

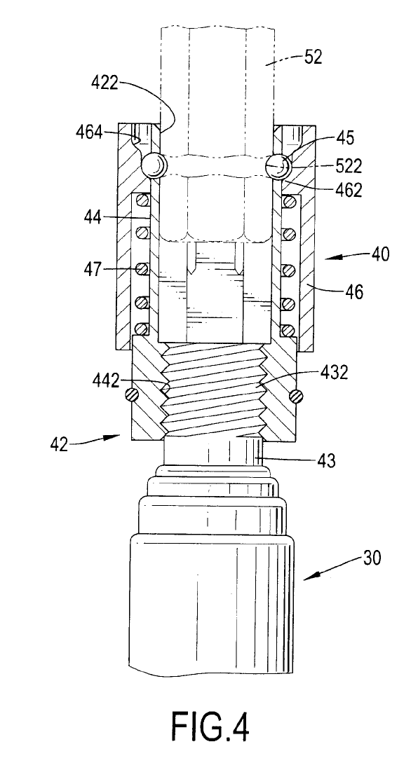

With further reference to FIG. 4, the second holding device (40) may have a structure substantially the same as that of the first holding device (20) or may comprise a second connecting stub (42), a second holding ball (45), a second holding sleeve (46) and a second spring (47). The second connecting stub (42) is mounted on and protrudes from the mounting end of the extension rod (10). The second connecting stub (42) can be integrally formed on or securely attached to the mounting end of the extension rod (30) and has a free end and a second connecting hole (422) defined in the free end of the second connecting stub (42). The second connecting stub (42) may be composed of a connecting protrusion (43) and a connecting sleeve (44). The connecting protrusion (43) is integrally formed on and protrudes from the mounting end of the extension rod (30) and has an outer thread (432). The connecting sleeve (44) has an inner thread (442) defined in one end of the connecting sleeve (44) and engaging the outer thread (432) on the connecting protrusion (43) to mount the connecting sleeve (44) onto the connecting protrusion (43). The second connecting hole (422) is defined in the other end of the connecting sleeve (44), is non-circular and may be hexagonal. The second holding ball (45) is retractably mounted in the second connecting stub (42) and protrudes into the second connecting hole (422). The second holding sleeve (46) is slidably mounted around the second connecting stub (42) to push the second holding ball (45) to partially protrude into the second connecting hole (422) and allow the second holding ball (45) to retract from the second connecting hole (422). The second holding sleeve (46) has an inner surface and an annular abutting flange (462) formed on the inner surface. An annular holding recess (464) is defined in the inner surface of the second holding sleeve (46) above the abutting flange (462). When the second holding sleeve (46) is slid downwardly to make the annular holding recess (464) align with the second holding ball (45), the second holding sleeve (46) can provide a space for the second holding ball (45) to retract into from the second connecting hole (422).

The second spring (47) is held in the second holding sleeve (46) and is mounted around the second connecting stub (42). The second spring (47) provides a force to the second holding sleeve (46) to make the abutting flange (462) abut against the second holding ball (45) and to press the second holding ball (45) to partially protrude into the second connecting hole (422).

The overhauling tool head (50A, 50B, 50C, 50D, 50E) is connected detachably to the mounting end of the telescopic extension rod (30) by the second holding device (40). The overhauling tool head (50A, 50B, 50C, 50D, 50E) may be but is not limited to a mirror (50A), a screwdriver (50B), a clamp, a pair of tweezers, a crocodile clamp (50C), a wrench, a magnetic set (50D), an illuminating device (50E) or the like and has a second connecting shaft (52). The second connecting shaft (52) is integrally or pivotally mounted on and protrudes from one end of the overhauling tool head (50A, 50B, 50C, 50D, 50E) and detachably mounted in the second connecting hole (422) of the second holding device (40) and has a non-circular cross section corresponding to the non-circular cross section of the second connecting hole (422). Preferably, the second connecting shaft (52) is hexagonal in cross section. An annular engaging detent (522) is defined around one end of the second connecting shaft (52) and detachably engages the second holding ball (45) of the second holding device (40) after the second connecting shaft (52) is inserted into the second connecting hole (422). With the engagement of the engaging detent (522) in the second connecting shaft (52) and the second holding ball (45) of the second holding device (40), the overhauling tool head (50A, 50B, 50C, 50D, 50E) is connected securely but detachably to the extension rod (30). Therefore, different kinds of tool heads (50A, 50B, 50C, 50D, 50E) can be attached to the extension rod (30).

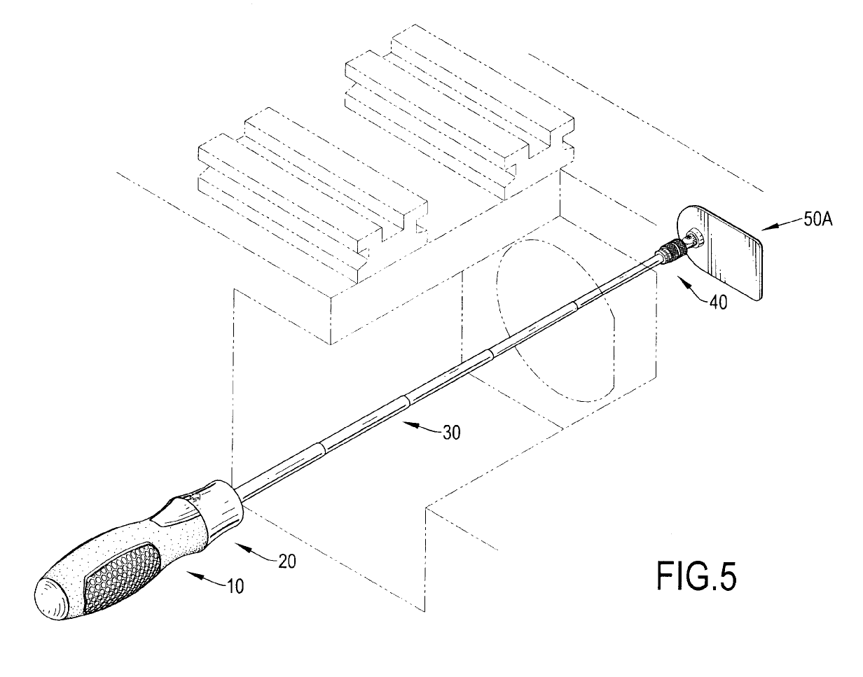

With further reference to FIG. 5, the overhauling tool head (50A, 50B, 50C, 50D, 50E) can be inserted into a checked machine or vehicle for an overhauling process after the extension rod (30) is extended to a desired length. For example, when the overhauling tool head (50A) is the mirror (50A) inside conditions of the machine or vehicle can be checked. When the overhauling tool head (50B) is the screwdriver (50B) or wrench, fastener, such as nuts or bolts can be tightened or released. When the overhauling tool head (50C, 50D) is a clamp, a crocodile clamp (50C) or a magnetic set (50D) a separate or redundant piece can be removed from the machine or vehicle. When the overhauling tool head (50E) is an illuminating device (50E), light is provided for aiding a dark environment such as at night or in a closed or covered hole. With the detachable and changeable overhauling tool heads (50A, 50B, 50C, 50D, 50E), an overhauling process to a machine or vehicle is easily and conveniently proceeded. With the multi-use, interchangeable tool in accordance with the present invention, to prepare multiple different kinds of tools for overhauling is unnecessary, and this is convenient to use and carry.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-use, interchangeable tool comprising:
a handle having
a mounting end; and
a first holding device mounted on the mounting end;
a telescopic extension rod connected detachably to the handle with the first holding device and having
a connecting end connected detachably to the mounting end of the handle by the first holding device;
a mounting end opposite to the connecting end; and
a second holding device mounted on the mounting end; and
an overhauling tool head connected detachably to the mounting end of the telescopic extension rod by the second holding device.

2. The multi-use, interchangeable tool as claimed in claim 1, wherein the first holding device comprises
a first connecting stub being mounted on the mounting end of the handle and having a free end and a first connecting hole defined in the free end of the first connecting stub;
a first holding ball being retractably mounted in the first connecting stub and protruding into the first connecting hole;
a first holding sleeve being slidably mounted around the first connecting stub to push the first holding ball to partially protrude into the first connecting hole and allow the first holding ball to retract into from the first connecting hole; and
a first spring being held in the first holding sleeve and mounted around the first connecting stub to provide a force to the first holding sleeve to press the first holding ball to protrude into the first connecting hole.

3. The multi-use, interchangeable tool as claimed in claim 2, wherein the first holding sleeve has
an inner surface;
an annular abutting flange formed on the inner surface of the first holding sleeve to press the first holding ball to protrude into the first connecting hole; and
an annular holding recess being defined in the inner surface of the first holding sleeve below the abutting flange to provide a space for the first holding ball to retract into from the first connecting hole.

4. The multi-use, interchangeable tool as claimed in claim 3, wherein the first holding device further has an outer sheath made of a resilient material mounted around the first holding sleeve.

5. The multi-use, interchangeable tool as claimed in claim 4, wherein the first connecting hole is hexagonal.

6. The multi-use, interchangeable tool as claimed in claim 5, wherein the extension rod has a first connecting shaft being integrally formed on and protruding from the connecting end of the extension rod, detachably mounted in the first connecting hole of the first holding device and having
a cross section corresponding to that of the first connecting hole; and
an annular engaging detent defined around one end of the first connecting shaft and detachably engaging the first holding ball of the first holding device.

7. The multi-use, interchangeable tool as claimed in claim 6, wherein the second holding device on the extension rod comprises
a second connecting stub being mounted on and protruding from the mounting end of the extension rod and having a free end and a second connecting hole being defined in the free end of the second connecting stub;
a second holding ball being retractably mounted in the second connecting stub and protruding into the second connecting hole;
a second holding sleeve being slidably mounted around the second connecting stub to push the second holding ball to partially protrude into the second connecting hole and allow the second holding ball to retract into from the second connecting hole;
a second spring being held in the second holding sleeve and mounted around the second connecting stub to provide a force to the second holding sleeve to press the second holding ball to protrude into the second connecting hole.

8. The multi-use, interchangeable tool as claimed in claim 7, wherein
the second connecting stub is composed of
a connecting protrusion being integrally formed on and protruding from the mounting end of the extension rod and having an outer thread; and
a connecting sleeve having an inner thread defined in one end of the connecting sleeve and engaging the outer thread on the connecting protrusion; and
the second connecting hole is defined in the connecting sleeve at one end opposite to the inner thread.

9. The multi-use, interchangeable tool as claimed in claim 8, wherein the second holding sleeve has
an inner surface;
an annular abutting flange formed on the inner surface of the second holding sleeve to push the second holding ball to protrude into the second connecting hole; and
an annular holding recess being defined in the inner surface of the second holding sleeve above the abutting flange to provide a space for the second holding ball to retract into from the second connecting hole.

10. The multi-use, interchangeable tool as claimed in claim 9, wherein the overhauling tool head has a second connecting shaft mounted on and protruding from one end of the overhauling tool head, detachably mounted in the second connecting hole of the second holding device and having
a cross section corresponding to that of the second connecting hole; and
an annular engaging detent defined around one end of the second connecting shaft and detachably engaging the second holding ball of the second holding device.

11. The multi-use, interchangeable tool as claimed in claim 10, wherein the overhauling tool head is selected from the group consisting of a minor, a screwdriver, a clamp, a crocodile clamp, a wrench, a magnetic set and an illuminating device.

12. The multi-use, interchangeable tool as claimed in claim 1, wherein the extension rod has a first connecting shaft being integrally formed on and protruding from the connecting end of the extension rod, detachably connected with the first holding device and having
a non-circular cross section; and
an annular engaging detent defined around and end of the first connecting shaft and detachably engaging the first holding device.

13. The multi-use, interchangeable tool as claimed in claim 1, wherein the second holding device on the extension rod comprises
a second connecting stub being mounted on and protruding from the mounting end of the extension rod and having a free end and a second connecting hole being defined in the free end of the second connecting stub;
a second holding ball being retractably mounted in the second connecting stub and protruding into the second connecting hole;
a second holding sleeve being slidably mounted around the second connecting stub to press the second holding ball to partially protrude into the second connecting hole and allow the second holding ball to retract into from the second connecting hole;
a second spring being held in the second holding sleeve and mounted around the second connecting stub to provide a force to the second holding sleeve to push the second holding ball to protrude into the second connecting hole.

14. The multi-use, interchangeable tool as claimed in claim 13, wherein
the second connecting stub is composed of
a connecting protrusion being integrally formed on and protruding from the mounting end of the extension rod and having an outer thread; and
a connecting sleeve having an inner thread defined in one end of the connecting sleeve and engaging the outer thread on the connecting protrusion; and
the second connecting hole is defined in the connecting sleeve at one end opposite to the inner thread.

15. The multi-use, interchangeable tool as claimed in claim 14, wherein the second holding sleeve has
an inner surface;
an annular abutting flange formed on the inner surface of the second holding sleeve to press the second holding ball to protrude into the second connecting hole; and
an annular holding recess being defined in the inner surface of the second holding sleeve above the abutting flange to provide a space for the second holding ball to retract into from the second connecting hole.

16. The multi-use, interchangeable tool as claimed in claim 1, wherein the overhauling tool head has a second connecting shaft mounted on and protruding from one end of the overhauling tool head, detachably connected with the second holding device and having
a non-circular cross section; and
an annular engaging detent defined around one end of the second connecting shaft and detachably engaging the second holding device.

17. The multi-use, interchangeable tool as claimed in claim 16, wherein the overhauling tool head is selected from the group consisting of a mirror, a screwdriver, a clamp, a crocodile clamp, a wrench, a magnetic set and an illuminating device.

18. The multi-use, interchangeable tool as claimed in claim 1, wherein the overhauling tool head is selected from the group consisting of a mirror, a screwdriver, a clamp, a crocodile clamp, a wrench, a magnetic set and an illuminating device.
